(19) United States
(12) Patent Application Publication
(10) Pub. No.: US 2021/0233150 A1
(43) Pub. Date: Jul. 29, 2021

(54) TRENDING ITEM RECOMMENDATIONS

(71) Applicant: Walmart Apollo, LLC, Bentonville (AR)

(72) Inventors: Evren KORPEOGLU, San Jose, CA (US); Sushant KUMAR, Sunnyvale, CA (US); Jiwen YOU, Sunnyvale, CA (US); Divya CHAGANTI, Dublin, CA (US); Kannan ACHAN, Saratoga, CA (US)

(21) Appl. No.: 16/776,209

(22) Filed: Jan. 29, 2020

(51) Int. Cl. G06Q 30/06; G06Q 30/02; G06F 16/2457

(52) U.S. Cl. CPC G06Q 30/0631; G06F 16/24578; G06Q 30/0206

(57) ABSTRACT

An approach is disclosed for recommending trending complementary items or trending similar items. The approach receives anchor item data corresponding to an anchor item. The approach determines a subcategory data corresponding to a category of the anchor item. The approach identifies an attribute label of the anchor item subcategory data, in which the attribute label indicates whether the anchor item is eligible for up-selling. The approach identifies, in response to the attribute label indicating that the anchor item is not eligible for up-selling, complementary subcategory data corresponding to the anchor item subcategory data, based on historical transaction data and at least one of co-view data and add-to-cart data. The approach generates recommended cross-selling item data from the complementary subcategory data, the recommended cross-selling item data being generated by applying a trending model to historical transaction data of items having complementary subcategory data.

### TECHNICAL FIELD

The disclosure relates generally to recommending complementary items or similar items, and more particularly, for recommending trending complementary items or trending similar items.

### BACKGROUND

When a customer purchases an item on an e-commerce website, the customer may select and add the item to, for example, the customer's online shopping cart. The e-commerce website may display the item (i.e., an anchor item) on an add-to-cart page (i.e., the online shopping cart), and recommend, via cross-selling, items that complement the anchor item. Typically, complementary items may include items that other customers purchased along with purchasing the anchor item.

Conventional cross-selling models may utilize co-purchase data of the anchor item to determine which complementary items to recommend and display. The co-purchase data may include a history of complementary items that other customers purchased when purchasing the anchor item. That is, the conventional cross-selling recommendation model may be an item-to-item co-purchase model, which may be built if there is enough historical and co-purchase data. Hence, the model only provides coverage for a small portion of the items listed for sale. For example, an e-commerce website may offer about eighty million items for sale; however of these eighty million items, customers may frequently purchase about ten million of these items. Customers may purchase the same complementary items for an anchor item, thereby creating co-purchase data for these anchor items and none for other anchor items. Thus, the cross-selling recommendation models may cover only ten out of eighty million items for sale.

To offer items that the conventional cross-selling model does not recommend, the e-commerce website may recommend and display these items in a general trending category on the add-to-cart page. However, these trending items may be the same for all anchor items, thereby preventing items that are more relevant to the anchor item but less popular than the trending items from being recommended and displayed. Moreover, customers may rarely interact with these trending items as they are generally irrelevant to the anchor item

### SUMMARY

The summary of the disclosure is given to aid understanding of providing trending complementary item recommendations or trending similar item recommendations, and not with an intent to limit the disclosure. The present disclosure is directed to a person of ordinary skill in the art. It should be understood that various aspects and features of the disclosure may advantageously be used separately in some instances, or in combination with other aspects and features of the disclosure in other instances. Accordingly, variations and modifications may be made to the systems, devices, and their methods of operation to achieve different effects. Certain aspects of the present disclosure provide a system, method, and non-transitory computer readable medium for providing trending complementary item recommendations or trending similar item recommendations.

The embodiments described herein are directed to a means of providing trending complementary item recommendations or trending similar item recommendations. The embodiments may provide trending item recommendations or trending similar item recommendations for cold start items or non-cold start items by leveraging data from subcategories and items within those subcategories. As such, the embodiments described herein may improve customer shopping experience by providing relevant trending item recommendations or trending similar item recommendations that complement a cold start item or a non-cold start item.

In one or more aspects, the disclosed technology relates to a system that comprises a memory having instructions stored thereon, and a processor configured to read the instructions. In one or more cases, the processor is configured to read the instructions to receive anchor item data corresponding to an anchor item. In one or more cases, the processor is configured to read the instructions to determine a subcategory data corresponding to a category of the anchor item. In one or more cases, the processor is configured to read the instructions to identify an attribute label of the anchor item subcategory data, in which the attribute label indicates whether the anchor item is eligible for up-selling. In one or more cases, the processor is configured to read the instructions to identify, in response to the attribute label indicating that the anchor item is not eligible for up-selling, complementary subcategory data corresponding to the anchor item subcategory data, based on historical transaction data and at least one of co-view data and add-to-cart data. In one or more cases, the processor is configured to read the instructions to generate recommended cross-selling item data from the complementary subcategory data. The recommended cross-selling item data may be generated by applying a trending model to historical transaction data of items having complementary subcategory data.

In one or more other aspects, the disclosed technology relates to a method. In one or more cases, the method comprises receiving anchor item data corresponding to an anchor item. In one or more cases, the method comprises determining category data corresponding to a category of the anchor item. In one or more cases, the method comprises identifying a label of the anchor item category data, in which the label indicates whether the anchor item is eligible for upselling. In one or more cases, the method comprises identifying, in response to the label indicating that the anchor item is not eligible for upselling, complementary category data corresponding to the anchor item category data, based on historical transaction data and at least one of co-view data and add-to-cart data. In one or more cases, the method comprises generate recommended cross-selling item data from the complementary category data, the recommended cross-selling item data being generated by applying a trending model to historical transaction data of items having complementary category data.

In yet one or more other aspects, the disclosed technology relates to a computer program product. In one or more cases, the computer program product comprises a non-transitory computer readable medium having program instructions stored thereon. In one or more cases, the program instructions may be executable by one or more processors. In one or more cases, the program instructions comprise receiving anchor item data corresponding to an anchor item. In one or more cases, the program instructions comprise determining category data corresponding to a category of the anchor item. In one or more cases, the program instructions comprise identifying a label of the anchor item category data, in which the label indicates whether the anchor item is eligible for upselling. In one or more cases, the program instructions comprise identifying, in response to the label indicating that the anchor item is not eligible for upselling, complementary category data corresponding to the anchor item category data, based on historical transaction data and at least one of co-view data and add-to-cart data. In one or more cases, the program instructions comprise generate recommended cross-selling item data from the complementary category data, the recommended cross-selling item data being generated by applying a trending model to historical transaction data of items having complementary category data.

### BRIEF DESCRIPTION OF THE DRAWINGS

The features and advantages of the present disclosure will be better understood when read in conjunction with the figures provided. Embodiments are provided in the figures for the purpose of illustrating aspects, and/or features, of the various embodiments, but the claims should not be limited to the precise arrangements, structures, features, aspects, methods, processes, assemblies, systems, or devices shown, and the arrangements, structures, features, aspects, methods, processes, assemblies, systems, and devices shown may be used singularly or in combination with other arrangements, structures, features, aspects, methods, processes, assemblies, systems, and devices.

FIG. 1 is a functional block diagram of a data processing environment, in accordance with one or more embodiments.

FIG. 2 is a functional block diagram illustrating components of the data processing environment of FIG. 1, in accordance with one or more embodiments.

FIG. 3 is a flowchart illustrating a process of providing trending item recommendations, in accordance with one or more embodiments.

FIG. 4A illustrates example complementary categories for an example anchor item category.

FIG. 4B illustrates example complementary categories for an example anchor item category.

FIG. 5A is an example view of a web page displaying example trending item recommendations.

FIG. 5B is another example view of a web page displaying example trending item recommendations.

FIG. 6 depicts a block diagram of components of a computing device capable of performing the processes described herein, in accordance with one or more embodiments.

### DETAILED DESCRIPTION

The following discussion omits or only briefly describes conventional features of the data processing environment, which are apparent to those skilled in the art. It is noted that various embodiments are described in detail with reference to the drawings, in which like reference numerals represent like drawing elements throughout the figures. Reference to various embodiments does not limit the scope of the claims attached hereto. Additionally, any examples set forth in this specification are intended to be non-limiting and merely set forth some of the many possible embodiments for the appended claims. Further, particular features described herein can be used in combination with other described features in each of the various possible combinations and permutations. The objectives and advantages of the claimed subject matter will become more apparent from the following detailed description of these embodiments in connection with the accompanying drawings.

Unless otherwise specifically defined herein, all terms are to be given their broadest possible interpretation including meanings implied from the specification as well as meanings understood by those skilled in the art and/or as defined in dictionaries, treatises, etc. It is also noted that, as used in the specification and the appended claims, the singular forms “a,” “an,” and “the” include plural referents unless otherwise specified, and that the terms “comprises” and/or “comprising,” when used in this specification, specify the presence or addition of one or more other features, aspects, steps, operations, elements, components, and/or groups thereof. Moreover, the terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

Embodiments of the disclosure relate generally to recommending complementary items or similar items, and more particularly, to recommending trending complementary items within subcategories or trending similar items. Embodiments that provide trending items are described below with reference to the figures.

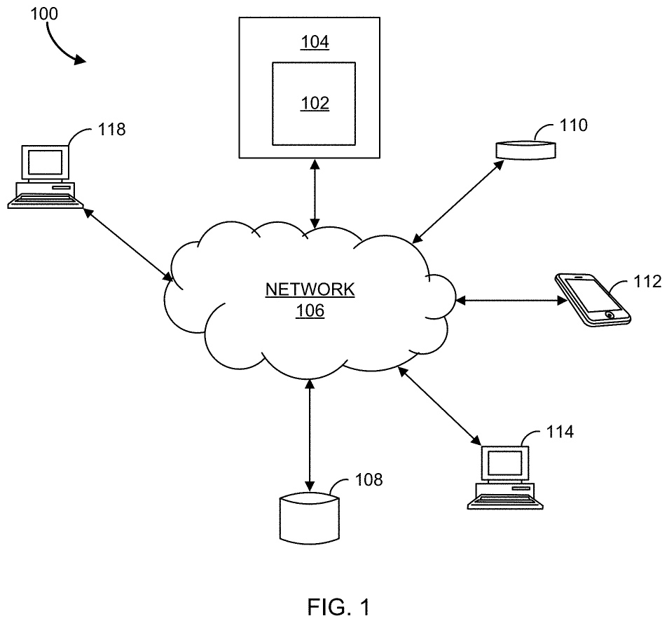

FIG. 1 is a functional block diagram of a data processing environment 100. FIG. 1 provides only an illustration of one implementation and does not imply any limitations with regard to the environments in which different embodiments may be implemented. Many modifications of the depicted environment may be made by those skilled in the art without departing from the scope of the claims. In one or more cases, the data processing environment 100 includes a server 104, which operates a complementary recommendation system 102 (hereinafter “system 102”), a data storage repository 108, and one or more computing devices, such as computing device 118 and customer devices 110, 112, and 114 coupled over a network 106. The server 104, system 102, data storage repository 108, and devices 110, 112, 114, and 118 can each be any suitable computing device that includes any hardware or hardware and software combination for processing and handling information, and transmitting and receiving data among the server 104, system 102, data storage repository 108, and devices 110, 112, 114, and 118.

The server 104, system 102, data storage repository 108, and devices 110, 112, 114, and 118 can each include one or more processors, one or more field-programmable gate arrays (FPGAs), one or more application-specific integrated circuits (ASICs), one or more state machines, digital circuitry, or any other suitable circuitry.

The network 106 interconnects the server 104, the data storage repository 108, and one or more of the devices 110, 112, and 114. In general, the network 106 can be any combination of connections and protocols capable of supporting communication between the server 104, the data storage repository 108, one or more of the computing devices 110, 112, 114, and 118, and the system 102. For example, the network 106 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. In one or more cases, the network 106 may include wire cables, wireless communication links, fiber optic cables, routers, switches, firewalls, or any combination that can include wired, wireless, or fiber optic connections known by those skilled in the art.

In one or more cases, the server 104 hosts the system 102. In some cases, the server 104 may be a web server, a blade server, a mobile computing device, a laptop computer, a tablet computer, a netbook computer, a personal computer (PC), a desktop computer, or any programmable electronic device or computing system capable of receiving and sending data, via the network 106, and performing computer-readable program instructions. For example, for the cases in which the server 104 is a web server, the server 104 may host one or more pages of a website. Each of the computing devices 110, 112, 114, and 118 may be operable to view, access, and interact with the web pages hosted by the server 104. In one or more examples, the server 104 hosts a website, such as an e-commerce website, for a retailer to sell items and for a customer to purchase an item via one or more web pages. For example, a user of a computing device, such as the computing device 110, 112, or 114, may access a web page, add one or more items to an online shopping cart, and perform an online checkout of the shopping cart to purchase the items. In another example, a user of the computing device 118 may access one or more aspects of the system 102, for instance, to upload an item to the e-commerce website. In other cases, the server 104 can be a data center, which includes a collection of networks and servers, such as virtual servers and applications deployed on virtual servers, providing an external party access to the system 102. In some other cases, the server 104 represents a computing system utilizing clustered computers and components (e.g., database server computer, application server computers, etc.) that act as a single pool of seamless resources, such as in a cloud computing environment, when accessed within data processing environment 100.

In one or more cases, the data storage repository 108 may store data including, but not limited to, items listed for sale on the e-commerce website (e.g., anchor item data 206), historical transaction data, co-purchase data, co-view data, add-to-cart data, category data 207, cross-selling label data, and upselling label data. Historical transaction data may be data that corresponds to the purchase history of an item. For example, historical transaction data may be data that indicates how many times customers purchased the item and/or when customers purchased the item. Co-purchase data may be data that corresponds to items that a user purchased together. For example, co-purchase data may include a user item interaction in which a user purchases item A and item B, which complements item A (e.g., item A is a television, and item B is a television mount), within the same transaction. Co-view data may be data that corresponds to sets of items that customers viewed within a period of time. For example, co-view data may include a user item interaction in which a user views item A and item B on the e-commerce web page, which item B may be similar to item A (e.g., item A is a 65 inch television having a first brand name and item B is a 65 inch television having a second brand name), within a time period of the user accessing the e-commerce web page and exiting the e-commerce web page. Add-to-cart data may be data that corresponds to an instance in which a customer adds an item to an online shopping cart.

In one or more cases, the data storage repository 108 may be one of, a web server, a mobile computing device, a laptop computer, a tablet computer, a netbook computer, a personal computer (PC), a desktop computer, or any programmable electronic device or computing system capable of receiving, storing, sending data, and performing computer readable program instructions capable of communicating with the server 104, computing devices 110, 112, 114, and 118, via network 106. In one or more cases, the data storage repository 108 may represent virtual instances operating on a computing system utilizing clustered computers and components (e.g., database server computer, application server computers, etc.) that act as a single pool of seamless resources when accessed within data processing environment 100. In one or more cases, the data storage repository 108 may be a remote storage device. In one or more other cases, the data storage repository 108 may be a local storage device on the server 104. For example, the data storage repository 108 may be, but not limited to, a hard drive, non-volatile memory, or a USB stick.

In one or more cases, devices 110, 112, 114, and 118 are clients to the server 104. The devices 110, 112, 114, and 118 may be, for example, a desktop computer, a laptop computer, a tablet computer, a personal digital assistant (PDA), a smart phone, a thin client, a voice assistant device, a digital assistant, or any other electronic device or computing system capable of communicating with server 104 through network 102. For example, device 118 may be a desktop computer capable of connecting to the network 106 to upload an item to the system 102. In another example, the device 112 may be a mobile device capable of connecting to the network 106 and receiving an input to add an item to a customer's online shopping cart on the e-commerce website. In one or more cases, one or more of the devices 110, 112, 114, and 118 may be any suitable type of mobile device capable of running mobile applications, including smart phones, tablets, slate, or any type of device that runs a mobile operating system.

In one or more cases, one or more of the devices 110, 112, 114, and 118 includes a user interface for providing an end user with the capability to interact with the system 102. For example, an end user of the computing device 118 may access the system 102 through the user interface to upload an item to sell on the e-commerce website. A user interface refers to the information (such as graphic, text, and sound) a program presents to a user and the control sequences the user employs to control the program. The user interface can be a graphical user interface (GUI). A GUI may allow users to interact with electronic devices, such as a keyboard and mouse, through graphical icons and visual indicators, such as secondary notations, as opposed to text-based interfaces, typed command labels, or text navigation. For example, the GUI may allow users to view, access, and interact with a website hosted on the server 104.

In one or more cases, one or more of the devices 110, 112, 114, and 118 can be any wearable electronic device, including wearable electronic devices affixed to, for example but not limited to, eyeglasses and sunglasses, helmets, wristwatches, clothing, and the like, and capable of sending, receiving, and processing data. For example, the device 110 may be a wearable electronic device, such as a wristwatch, capable of accessing an e-commerce website and receiving an input to add an item to a customer's cart on the e-commerce website.

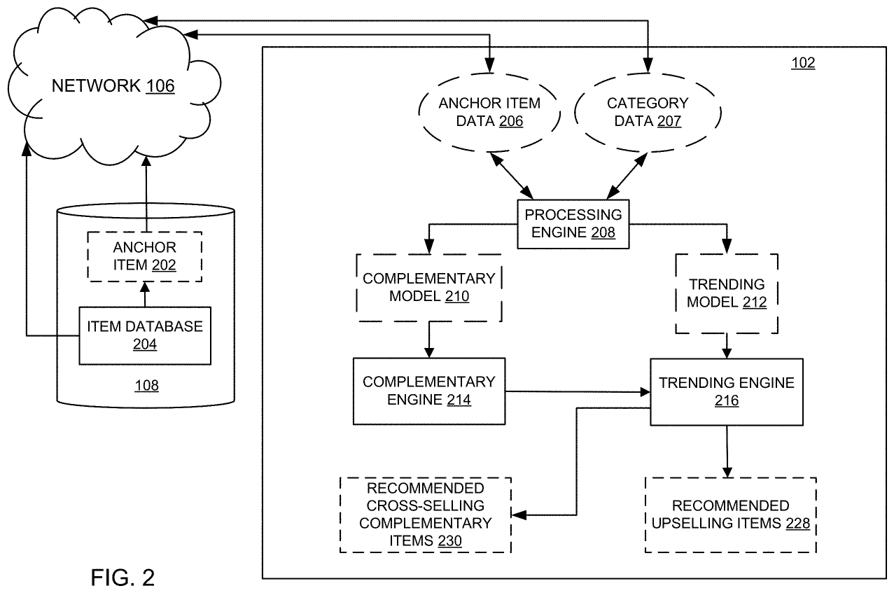

FIG. 2 is a functional block diagram illustrating components of the data processing environment 100 of FIG. 1.

In one or more cases, the data storage repository 108 includes one or more databases for storing information. For example, the data storage repository 108 may include an item database 204. The item database 204 may store items listed for sale on the e-commerce website (e.g., anchor item data 206), historical transaction data, co-purchase data, co-view data, add-to-cart data, category data 207, cross-selling label data, and upselling label data. It is noted that FIG. 2 illustrates the item database 204 as singular database localized on the data storage repository 108; however, it should be understood that the data stored within the item database 204 may be stored on more than one database that are either local to or remote from the data storage repository 108

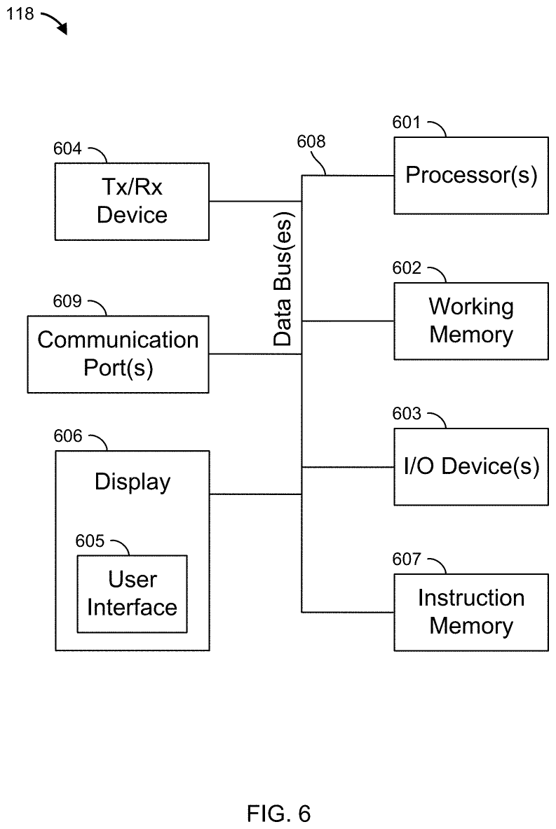

In one or more cases, the system 102 includes a processing engine 208, a complementary engine 214, and a trending engine 216. In one or more examples, one or more of the processing engine 208, the complementary engine 214, and the trending engine 216 may be implemented in hardware. In one or more examples, one or more of the processing engine 208, the complementary engine 214, and the trending engine 216 may be implemented as an executable program maintained in a tangible, non-transitory memory, such as instruction memory 607 of FIG. 6, which may be executed by one or processors, such as processor 601 of FIG. 1.

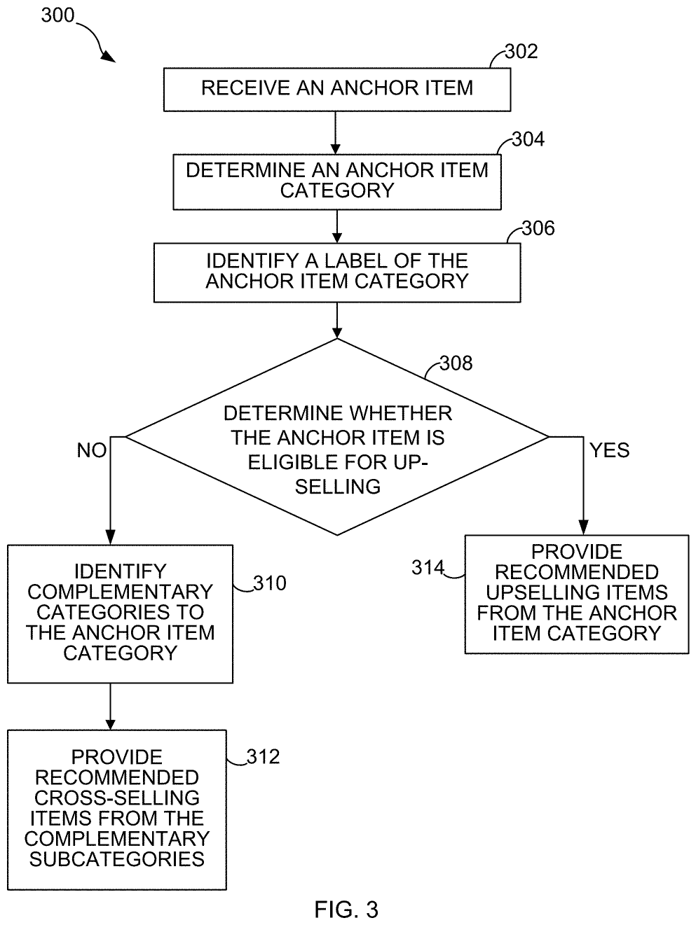

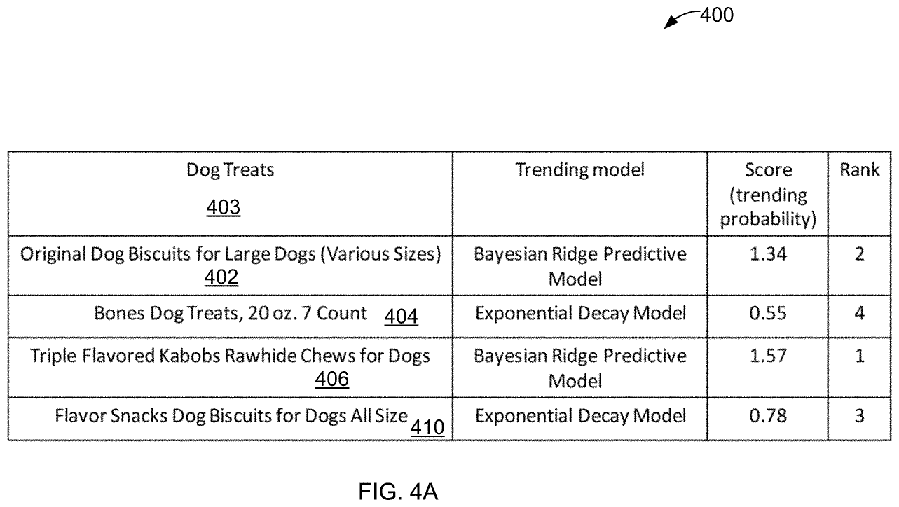

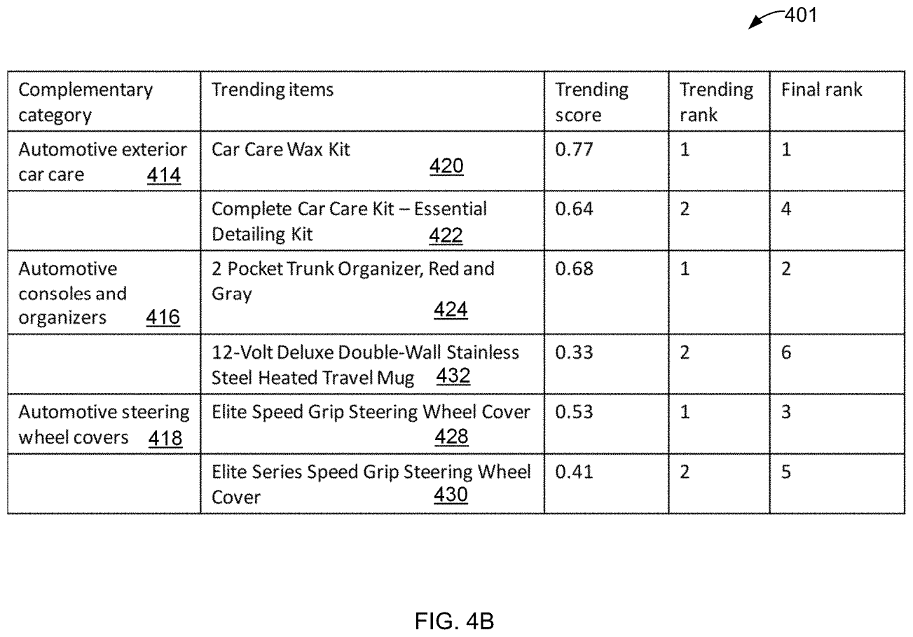

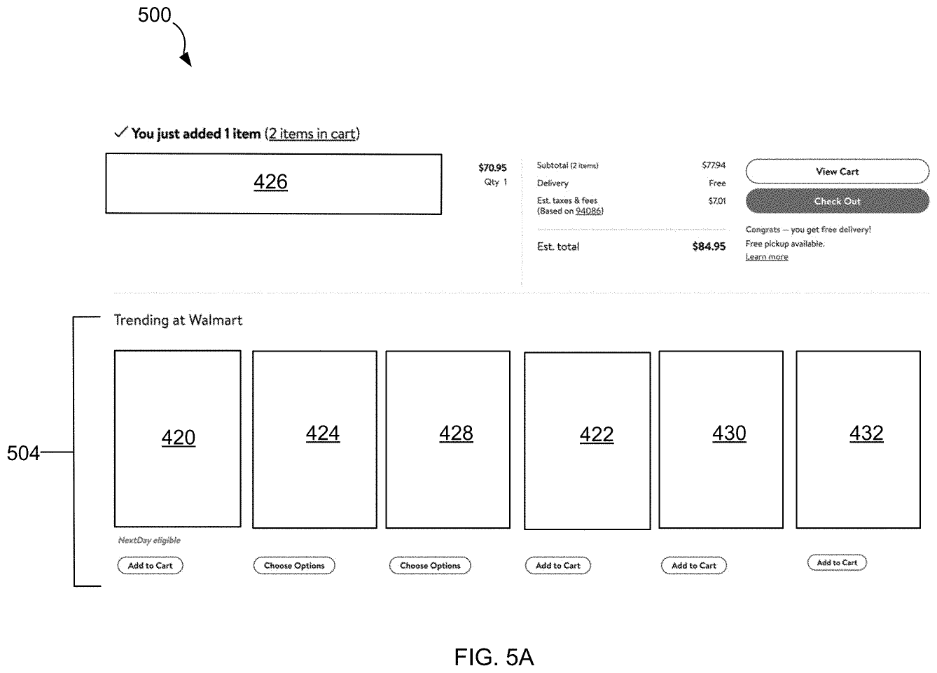

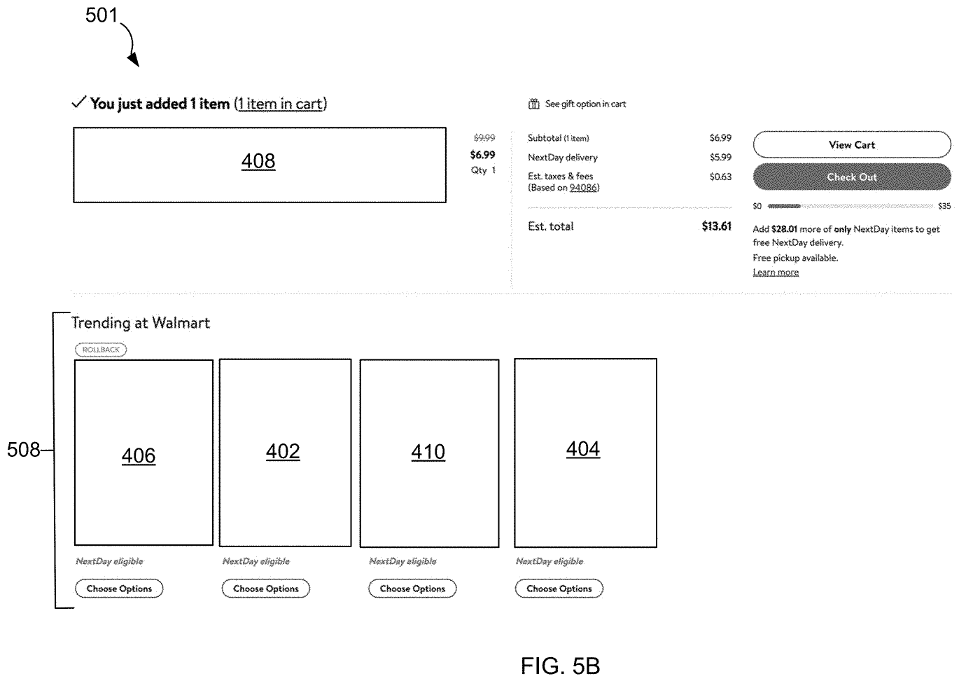

FIG. 3 is a flowchart illustrating a process 300 of providing complementary item recommendations. FIG. 4A illustrates example complementary categories for an example anchor item category. FIG. 5A is an example view of a web page displaying example trending item recommendations for a cross-selling anchor item category. FIG. 4B illustrates example complementary categories for an example anchor item category. FIG. 5B is an example view of a webpage displaying example trending item recommendations for an upselling anchor item category.

It is noted that, while the examples discussed herein are directed to recommending trending complementary items or trending similar items for televisions, dog products, and car products, the embodiments discussed herein may be used to provide complementary recommendations for any type of product offered for sale, and are not limited to recommending trending complementary items or trending similar items for televisions, dog products, and car products. Moreover, the embodiments discussed herein may be directed to recommending trending complementary items or trending similar items for any type of product within any category of the e-commerce website.

An anchor item is received (302), preferably by the system 102. In one or more cases, the system 102 receives the anchor item 202 from the data storage repository 108. For example, the data storage repository 108 may retrieve anchor item data 206 corresponding to the anchor item 202 from the item database 204, and transmit the anchor item data 206 to the processing engine 208 of the system 102, via the network 106. In one or more cases, the anchor item 202 can be any item listed on the e-commerce website. The anchor item 202 can be a cold start item or a non-cold start item. The example discussed herein utilizes a cold start anchor item. A cold start item may be an item that was not purchased (i.e., an item that does not have historical transaction data), not purchased with one or more complimentary items (i.e., an item that does not have co-purchase data), or that does not have enough historical transaction data and/or co-purchase data for the system 102 to input into a conventional cross-selling model and provide a customer with complementary item recommendations, similar item recommendations or into a conventional upselling model and provide a customer with upselling item recommendations for the cold start item. In contrast to the cold start item, a non-cold start item may be an item that has enough historical transaction data and/or co-purchase data to input into a conventional cross-selling model and provide a customer with complementary item recommendations, similar item recommendations or into a conventional upselling model and provide a customer with upselling item recommendations for the non-cold start item. In one or more cases, the system 102 may receive the anchor item 202 in response to a user adding the anchor item 202 to the online shopping cart. For example, the system 102 may receive a cold start anchor item 202 in response to a user adding the cold start anchor item 202 to the online shopping cart.

A category of the anchor item 202 is determined (304), preferably by the processing engine 208. In one or more cases, having received the anchor item data 206, the processing engine 208 determines the anchor item category. In one or more cases, the system 102 may predetermine, via one or more machine learning algorithms, a category corresponding to an item listed for sale on the e-commerce website, and may store the relationship between the category and the corresponding item as category data 207 in the item database 204. To determine the anchor item category, the processing engine 208 may retrieve category data 207, corresponding to the anchor item data 206, from the data storage repository 108. For example, the processing engine 208 may determine from the anchor item data 206 that the anchor item 202 is a 65-inch 4K Ultra HP (2160P) HDR Smart LED TV. Based on the anchor item data 206, the processing engine 208 may retrieve the associated anchor item category data 207 from the data storage repository 108 and determine that the anchor item 202 belongs to the TV mounts and antennas category. In another example, the processing engine 208 may determine from the anchor item data 206 that the anchor item 202 is a package of Gingerbread Flavor Regular Size Dental Dog Treats, 6-ounce pack (e.g., shown as 408 in FIG. 5B). Based on the anchor item data 206, the processing engine 208 may retrieve the associated anchor item category data 207 from the data storage repository 108 and determine that the anchor item 202 belongs to the dog treats category 403, as shown in FIG. 4A. In yet another example, the processing engine 208 may determine from the anchor item data 206 that the anchor item 202 is a set of Front Floor Mats (e.g., shown as 426 in FIG. 5A). Based on the anchor item data 206, the processing engine 208 may retrieve the associated anchor item category data 207 from the data storage repository 108 and determine that the anchor item 202 belongs to the automotive floor mats category.

A label of the anchor item category is identified (306), preferably by the processing engine 208. In one or more cases, the processing engine 208 may identify a label of the anchor item category as being, for example, a cross-selling label or an upselling label. A cross-selling label may be data that indicates cross-selling items may be recommended for the items within the corresponding anchor item category. That is, the system 102 may analyze the data of the cross-selling label and determine that the system 102 recommends one or more items that complement the anchor item. An upselling label may be data that indicates upselling items may be recommended for the items within the corresponding anchor item category. That is, the system 102 may analyze the data of the upselling label and determine that the system 102 recommends an upgraded or premium version of the anchor item or a similar item to the anchor item that is higher-end or more expensive than the anchor item.

In one or more cases, the system 102 may predetermine whether a category includes the cross-selling label or the upselling label and store the cross-selling label or upselling label in the item database 204. The system 102 may determine which label to apply to a category based on at least one of historical transaction data, co-purchase data, co-view data, and add-to-cart data of user interactions with the e-commerce website. For example, the system 102 may compile data, e.g., historical transaction data, co-view data, co-purchase data, and add-to-cart data, as attributes corresponding to user interactions for a coffee grounds category, and determine a pattern for the user interactions. For instance, if a user added coffee grounds to the online shopping cart and further explored other flavors of coffee grounds, the system 102 groups the data for these user interactions together as co-view data. If, for example, the system 102 determines a majority of the data for coffee grounds relates to user interactions in which users browsed or purchased different flavors of coffee grounds, the system 102 may determine that the coffee grounds category includes an upselling label. In another example, the system 102 may compile data, e.g., historical transaction data, co-view data, co-purchase data, and add-to-cart data, as attributes corresponding to user interactions for a television category, and determine a pattern for the user interactions. In one or more other cases, the system 102 may label consumable categories with an upselling label. For instance, if a user added a television to the online shopping cart and further searched for a television mount and/or other television accessories, the system 102 groups the data for these user interactions together as co-view data. If, for example, the system 102 determines a majority of the data for the television category relates to user interactions in which users added a television to the online shopping cart and then added television accessories to the online shopping cart, the system 102 may determine that the television category includes a cross-selling label.

In one or more cases, to determine a pattern for the user interactions, the system 102 may use a clustering algorithm to identify whether the anchor item category includes a cross-selling label or an upselling label. The system 102 may use a clustering algorithm, such as, but not limited to, K-means clustering, mean-shift clustering, density-based spatial clustering of applications with noise (DBSCAN), expectation-maximization (EM) clustering using Gaussian mixture models (GMM), agglomerative hierarchical clustering, and other like clustering algorithms. The system 102 may apply at least one of historical transaction data collected over a period of time, co-purchase data collected over a period of time, co-view data collected over a period of time, and add-to-cart data collected over a period of time in the clustering algorithm to identify whether the anchor item category includes a cross-selling label or an upselling label. For example, the system 102 may use 6 months of historical transaction data, 3 months of co-view data, and 1 month of add-to-cart data in the clustering algorithm to determine that the package of Gingerbread Flavor Regular Size Dental Dog Treats 408 includes an up-selling label. In another example, the system 102 may use 4 months of historical transaction data, 6 weeks of co-view data, and 17 days of add-to-cart data in a clustering method to determine that the set of Front Floor Mats 426 includes a cross-selling label.

A determination is made (308), preferably by the processing engine 208, as to whether the anchor item 202 is eligible for upselling. In one or more cases, the processing engine 208 determines that the anchor item 202 is eligible for upselling by determining that the anchor item category includes an upselling label. Having determined that the anchor item category includes an upselling label, the processing engine 208 determines that the anchor item 202 is eligible for upselling. In one or more other cases, the processing engine 208 determines that the anchor item 202 is not eligible for upselling by determining that the anchor item category includes a cross-selling label.

For the cases in which the processing engine 208 determines that the anchor item 202 is eligible for upselling (308: YES), the processing engine 208 sends the anchor item category data 207 to the trending engine 216. Having received the anchor item category data 207, the trending engine 216 provides recommended upselling items 228 from the anchor item category (314). For example, the trending engine 216 provides recommended upselling items 228, such as items 508 in FIG. 5B from the anchor item category 400 in FIG. 4A. In one or more cases, the trending engine 216 provides the recommended upselling items 228 to an end user, such as a customer. The trending engine 216 may provide the recommended upselling items 228 by transmitting, via the system 102 and the network 106, the recommended upselling items 228 to a client device, for example, client device 112. The client device 112 may display the anchor item 202, e.g., the Gingerbread Flavor Regular Size Dental Dog Treats 408, along with the recommended upselling items 508 on the add-to-cart page 501 of the e-commerce website, as shown in FIG. 5B. In one or more cases, the items within the anchor item category may be upselling items that are similar to the anchor item.

In one or more cases, the trending engine 216 may apply a trending model 212 to the anchor item category to generate the recommended upselling similar items 228. That is, the trending engine 216 applies the trending model 212 to the anchor item category data 207 and generates recommended upselling items 228. For example, the trending engine 216 applies the trending model 212 to the data corresponding to the one or more items within the anchor item category 400 shown in FIG. 4A, and generates the recommended upselling items 508 displayed on the add-to-cart page 501 shown in FIG. 5B.

In one or more cases, the trending model 212 may include at least one of an Exponential Decay Model and a Bayesian Ridge Predictive Model. For example, utilizing the Exponential Decay Model, the trending engine 216 applies the trending model 212 to historical transaction data of the items within the anchor item category. The trending model 212 may apply an exponentially decreasing weight (exp(−k)) to the historical transaction data over a period of time. That is, the trending model 212 applies more weight to the most recent historical transaction data than to older historical transaction data. For example, the trending model 212 may apply a weight of 0.368 (e.g., exp(−1)) to the historical transaction data collected one day prior, and a weight of 0.135 (e.g., exp(−2)) to the historical transaction data collected two days prior. The trending model 212 may output a score (Sᵢ), shown below, which is the sum of exponential weight (exp(−k)) times the historical transaction data (t(i,k)) for every item sold on the e-commerce website.
t_{i,k}: transaction data for item i on the past k^{th} date
e^{-k}: weight for the past k^{th} date transaction data

$${S}_{i} = {\sum }_{k}^{K} {e}^{- k} * {t}_{i , k}$$

For example, the trending engine 216 applies the trending model 212 using the Exponential Decay Model to the Bones Dog Treats, 20 oz. 7 Count 404 to output a score of 0.55, and to the Flavor Snacks Dog Biscuits for Dogs All Size 410 to output a score of 0.78. The score (Sᵢ) may indicate a trending probability for an item within the anchor item category, such as anchor item category 400. A trending probability indicates the probability that an item is a trending item. For example, the trending engine 214 may determine that the higher the score is for an item, the higher the probability is that the item is a trending item. The trending engine 216 may rank the items within the anchor item category based on their trending probability, and may provide the ranked items as recommended upselling items 228. For example, the trending engine 216 may rank the Flavor Snacks Dog Biscuits for Dogs All Size 410, and Bones Dog Treats, 20 oz. 7 Count 404 from having the highest trending probability to the lowest trending probability. The trending engine 216 may provide the trending items 410 and 404 as recommended upselling items 508 (i.e., recommended upselling items 228) to the anchor item 408. The trending engine 216 may provide the data of items 410 and 404 to an end user's device, such as client device 112. Client device 112 may display the items 410 and 404 in descending order on the add-to-cart page 501 of the e-commerce website, as shown in FIG. 5B.

In another example, utilizing the Bayesian Ridge Predictive Model, the trending engine 216 applies the trending model 212 to the historical transaction data of items within the anchor item category. The trending model 212 implements feature engineering to construct features of the Bayesian Ridge predictive model. The features of the Bayesian Ridge Predictive Model may include, but are not limited to, item historical sales data and item historical sales difference data. For example, item historical sales data may include the number of sales for an item, and the item historical sales difference data may include to a one day's sale difference for an item, i.e., the number of sales for an item on one day minus the number of sales for the item on the previous day. In one or more cases, the Bayesian Ridge Predictive Model may be a regression model that predicts the sales increase for every item sold on the e-commerce website in the next day (i.e., the next day sales increase). The trending model 212 may output a score, which is the predicted sales increase for the item, for one or more items within the anchor item category. For example, the trending engine 216 applies the trending model 212 using the Bayesian Ridge Predictive Model to the Original Dog Biscuits for Large Dogs (Various Sizes) 402 to output a score of 1.34, and to the Triple Flavored Kabobs Rawhide Chews for Dogs 406 to output a score of 1.57. For the cases in which the score is positive, the system 102 may determine that several more transactions may occur for the item for the next day (e.g., customers may purchase the item several times during the next day), and determine that the item is a trending item, i.e., the item is trending upwards. For the cases in which the score is negative, the system 102 may determine that the amount of transactions for the item will decrease for the next day, and determine that the item is trending downwards. The score may indicate the trending probability for an item within the anchor item category, such as anchor item category 400, in which items with a higher score indicate a higher probability that the item is a trending item. The trending engine 216 may rank the items within the anchor item category based on the trending probability of whether the item will sell in the next day. The trending engine 216 may pick items with high trending scores and rank them from having the highest trending probability to the lowest trending probability. For example, the trending engine 216 may rank the Triple Flavored Kabobs Rawhide Chews for Dogs 406, and the Original Dog Biscuits for Large Dogs (Various Sizes) 402 from having the highest trending probability to the lowest trending probability. The trending model 212 may provide the items 406 and 402 as recommended upselling items 508 (i.e., recommended upselling items 228) to the anchor item 408. The trending engine 216 may provide the data of items 406 and 402 to an end user's device, such as client device 112. Client device 112 may display the items 406 and 402 in descending order on the add-to-cart page 501 of the e-commerce website, as shown in FIG. 5B.

In yet another example, utilizing more than one model, such as the Exponential Decay Model and the Bayesian Ridge Predictive Model, the trending model 212 generates, for each model, a list of trending items for the anchor item category. The trending engine 216 may concatenate the lists of trending items into one list of trending items recommendation based on the trending scores. For example, given the anchor item 408, the Exponential Decay Model generates the trending items 404 and 410, and the Bayesian Ridge Predictive Model generates trending items 402 and 406. The trending engine 216 may rank the trending items based on the scores produced from the Exponential Decay model and the Bayesian Ridge Predicative Model to provide items 406, 402, 410, and 404 as recommended upselling items 228 to the anchor item 202. The trending engine 216 may provide the data of items 406, 402, 410, and 404 to an end user's device, such as client device 112. Client device 112 may display the items 406, 402, 410, and 404 in descending order on the add-to-cart page 501 of the e-commerce website, as shown in FIG. 5B.

For the cases in which the processing engine 208 determines that the anchor item 202 is not eligible for upselling (308: NO), the processing engine 208 sends the anchor item category data 207 to the complementary engine 214. For example, the processing engine 208 may send the anchor item category data for the automotive floor mats category to the complementary engine 214. Having received the anchor item category data 207, the complementary engine 214 identifies complementary categories to the anchor category (310). For example, the complementary engine 214 may identify the automotive exterior car care category 414, automotive consoles and organizers category 416, automotive steering wheel covers category 418 as being complementary categories to the automotive floor mats category. In one or more cases, the items within the complementary categories may be items that complement the anchor item 202, e.g., items that may be cross-sold with the anchor item 202.

In one or more cases, to identify complementary categories, the complementary engine 214 applies a complementary model 210 to historical transaction data and customer online shopping micro-behavior data, for example, but not limited to, co-view data and add-to-cart data. In one or more cases, the complementary model 210 may be a machine learning model that reflects a complementary relationship and/or a directional relationship of a category to the anchor item category. The complementary relationship may refer to data indicating a correlation between an item that is purchased or consumed jointly with another item. Directional relationship may refer to an item purchase order. In one or more cases, the system 102 may determine an item purchase order based on at least one of historical transaction data and add-to-cart data. A directional relationship may refer to primary item being purchased or added to an online shopping cart before purchasing or adding a secondary item to the online shopping cart. For example, based on the heuristic generated by inputting the historical transaction data into the machine learning model to determine a directional relationship, the system 102 may determine that about 73% of customers purchase or add a television to an online shopping cart first and then purchase or add television accessories to the online shopping cart, in which case the directional relationship may include the primary item being a television and the secondary item being television accessories. An inverse relationship may refer to a secondary item being purchased before a primary item. For example, an inverse relationship may include a customer purchasing the television accessories and then purchasing the television. A bi-directional relationship may refer to one item that is purchased or added to an online shopping cart and another item that is subsequently purchased or added to the online shopping cart, in which the probability that a customer adds either item to the online shopping cart first is the same. For example, a bi-directional relationship may include two items, such as laundry detergent and laundry dryer sheets, in which the probability that a customer purchases or adds either item to the online shopping cart is the same.

In one or more cases, the complementary model 210 may utilize one or more algorithms to determine the complementary relationship of categories to the anchor item category. For example, the complementary model 210 may use an Apriori Algorithm to frequently mine item sets and apply association rule learning over relational databases. Association rule learning is a rule-based machine learning method for discovering interesting relationships between variables in large databases. The complementary model 210 may apply the Apriori algorithm to the historical transaction data of the e-commerce website in order to determine interesting associations and relationships among large sets of items. By utilizing the Apriori algorithm, the complementary engine 214 may apply the complementary model 210 to the historical transaction data to output a frequency at which a set of categories, for example, an automotive floor mats category and an automotive exterior car care category, occurs per transaction, and may generate a frequency score based on these occurrences. For example, the complementary engine 214 may apply the complementary model 210 to the automotive floor mats anchor item category, and generate a frequency score for one or more combinations of categories. For example, the complementary engine 214 may determine that the frequency score for the category set including the automotive floor mats category and the automotive exterior car care category 414 is 0.32. In another example, the complementary engine 214 may determine that the frequency score for the category set including the automotive floor mats category and the automotive consoles and organizers category 416 is 0.14. In yet another example, the complementary engine 214 may determine that the frequency score for the category set including the automotive floor mats category and the dog treats category 403 is 0.02. In one or more cases, the complementary engine 214 may determine that a higher frequency score indicates a stronger complementary relationship between the categories. The complementary model 210 may identify the frequently co-purchased categories according to the frequency score.

In another example, the complementary model 210 may use a Kullback-Leibler (KL) Divergence algorithm to measure how one probability distribution, e.g., probability distribution A, is different from another probability distribution, e.g., probability distribution B, in order to determine the complementary relationship of categories to the anchor item category. Probability distribution B is the probability distribution (Q(i,j)) that an item from category i and an item from category j are purchased together. For instance, a KL divergence algorithm may be:

$${D}_{K L}^{( i , j )} ( P \vert Q ) = P ( i ) * P ( j ) log ( \frac{P ( i ) * P ( j )}{Q ( i , j )} )$$

in which i=anchor category; j=complementary subcategory; P(i)=probability distribution that a customer purchases one or more items from anchor category i; Q(i, j): probability distribution of a customer purchasing items within anchor category i together with items within subcategory j; D_{KL}^{(i,j)}: KL divergence value between anchor category i and subcategory j. When two events M and N are independent, the joint probability of events M and N equals the product of their probabilities, i.e., P(M, N)=P(M)*P(N). If categories i and j are independent (e.g. car accessories category and a TV category), the probability distribution that the items from both categories i and j are purchased together (Q(i,j)) equals P(i)*P(j), and the KL divergence score should equal 0. If categories i and j are complementary to one other (e.g., a TV category and a TV mounts category) and are frequently purchased together, the KL divergence score is positive. In contrast, if the categories are supplementary to one other (e.g., an iPhone category and an Android phone category), the KL divergence score is negative. The system 102 may determine that a higher KL divergence score indicates a stronger complementary relationship between the categories. For example, the KL divergence score between the automotive floor mats category and the automotive steering wheel covers category 418 is 0.867. In another example, the KL divergence score between the automotive floor mats category and the dog treats category is 0.025.

In yet another example, the complementary model 210 may use an item-to-item complementary correlation algorithm to aggregate item level information to the category level and explore the category level correlation. The item-to-item complementary correlation algorithm may provide item level complementary item recommendation given an anchor item. For example, given an anchor item, such as Essentials Ocean Breeze Moisturizing Shampoo for Dry Hair that is included in the shampoo category, the complementary model 210 generates item recommendations, such as, a (2 Pack) Essentials Tropical Coconut Conditioner that is included in the conditioner category and a Speed Stick Men's Deodorant, Regular—3-ounce Twin Pack that is included in the deodorants & antiperspirants category. The complementary model 210 aggregates item level information to the category level such that the complementary model 210 can identify the categories conditioner and deodorants & antiperspirants as the complementary categories to the anchor category shampoo.

The complementary engine 214 may apply one or more of the above algorithms (e.g., the Apriori Algorithm, the KL Divergence Algorithm, and the item-to-item complementary correlation algorithm), via the complementary model 210, and generates a complementary score for the categories. In one or more cases, the complementary engine 214 may apply a boosting algorithm to the complementary scores generated from one or more of the aforementioned algorithms (e.g., the Apriori Algorithm, the KL Divergence Algorithm, and the item-to-item complementary correlation algorithm) in order to algorithmically aggregate complementary relationships between the complementary categories and the anchor item category. The complementary model 210 may apply the boosting algorithm, which is an ensemble algorithm, to determine and rank the complementary categories given an anchor item category based on the score generated from aforementioned techniques. Based on the complementary scores, the complementary engine 214 may determine the complementary categories to the anchor item category. For example, the complementary engine 214 may determine that categories, automotive exterior car care category 414, automotive consoles and organizers category 416, and automotive steering wheel covers category 418, are complementary subcategories to the automotive floor mats category. In one or more cases, the complementary model 210 may remove categories that have an inverse relationship to the anchor category. For example, if the anchor item category is a TV mount category, the complementary model 210 may remove a TV category from the complementary categories, as the TV category has an inverse relationship with the anchor item TV mount category. In one or more cases, the complementary engine 214 may rank the complementary categories based on the complementary score. The complementary engine 214 may provide the complementary categories to the trending engine 216 to determine one or more trending items from the complementary categories.

Having determined the complementary categories to the anchor item category, recommended cross-selling complementary items 230 from the complementary categories may be provided (312), preferably by the trending engine 216. In one or more cases, the trending engine 216 provides the recommended cross-selling complementary items 230 from the complementary categories to an end user, such as a customer. The trending engine 216 may provide the recommended cross-selling complementary items 230 by transmitting, via the system 102 and the network 106, the recommended cross-selling complementary items 230 to a client device, for example, client device 112. The client device 112 may display the anchor item 202, e.g., the Front Floor Mats 426, along with the recommended cross-selling complementary items 504 on the add-to-cart page 500 of the e-commerce website, as shown in FIG. 5A.

To provide the recommended cross-selling complementary items 230 from the complementary categories, the trending engine 216 may identify trending items within each of the complementary categories in a same or similar manner as the trending engine 216 determining the recommended upselling complementary items 228 for the anchor item category, such as anchor item category 400. For example, the trending engine 216 may apply the trending model 212 to the one or more items within each complementary category, such as complementary categories 414, 416, and 418. The trending model 212 may include at least one of an Exponential Decay Model and a Bayesian Ridge Predictive Model. The trending model 212 may output a score that indicates a trending probability for an item within the complementary category as discussed herein. In one or more cases, the trending engine 216 may rank the items within each complementary category based on their trending probability. For example, for the automotive exterior car care category 414, the trending model 212 may output a score of 0.77 for the Car Care Wax Kit item 420 and a score of 0.64 for the Complete Car Care Kit—Essential Detailing Kit item 422, in which item the trending engine 216 ranks item 420 first and item 422 second within the automotive exterior car care category 414. For the Automotive consoles and organizers category 416, the trending model 212 may output a score of 0.86 for the 2 Pocket Trunk Organizer, Red and Gray item 424 and a score of 0.33 for the 12-Volt Deluxe Double-Wall Stainless Steel Heated Travel Mug item 426.

In one or more cases, the trending engine 216 aggregates the trending items from the complementary categories. Given the anchor item category, automotive floor mats, the trending engine 216 identifies three complementary categories, e.g., the automotive exterior car care category 414, the automotive consoles and organizers category 416, and the automotive steering wheel covers category 418. To aggregate the trending items among the complementary categories, the trending engine 216 selects and ranks the top trending items from each category based on trending scores. The trending engine 216 subsequently selects and ranks the next top trending items from each category, and repeats the selecting and rank process until the trending engine 216 selects and ranks trending items from each category. In one or more cases, the trending engine 216 diversifies the trending items between categories, such that items from the same category are not recommended next to one another. The trending engine 216 may rank the diversified and aggregated trending items based on their trending probability, and may provide the ranked items as recommended cross-selling items 230. For example, the trending engine 216 may rank the Car Care Wax Kit item 420, the 2 Pocket Trunk Organizer, Red and Gray item 424, the Elite Speed Grip Steering Wheel Cover item 428, the Complete Car Care Kit—Essential Detailing Kit item 422, the Elite Series Speed Grip Steering Wheel Cover item 430, and the 12-Volt Deluxe Double-Wall Stainless Steel Heated Travel Mug item 432 from having the highest trending probability to the lowest trending probability. The trending engine 216 may provide the items 420, 424, 428, 430, and 432 as recommended cross-selling items 504, which are displayed in descending order on the add-to-cart page 500 of the e-commerce website, as shown in FIG. 5A.

In one or more cases, compared to the click through rate of 1.83% for the items recommended by the conventional models, the recommended cross-selling complementary items and the recommended upselling items provided by the process 300 and the system 102 may create a click through rate of about 6.16% and increase user interaction with the items recommended by the website. Moreover, the process 300 and the system 102 may improve the coverage of items to about 100% compared to the 70% coverage that the conventional models may provide.

FIG. 6 depicts a block diagram of components of a computing device capable of performing the processes described herein. In particular, FIG. 6 illustrates an example computing device, such as computing device 118, capable of interacting with the system 102 of FIG. 1.

Computing device 118 can include one or more processors 601, working memory 6602, one or more input/output devices 6603, instruction memory 607, a transceiver 604, one or more communication ports 609, and a display 606, all operatively coupled to one or more data buses 608. Data buses 608 allow for communication among the various devices. Data buses 608 can include wired, or wireless, communication channels.

Processors 601 can include one or more distinct processors, each having one or more cores. Each of the distinct processors can have the same or different structure. Processors 601 can include one or more central processing units (CPUs), one or more graphics processing units (GPUs), application specific integrated circuits (ASICs), digital signal processors (DSPs), and the like.

Processors 601 can be configured to perform a certain function or operation by executing code, stored on instruction memory 607, embodying the function or operation. For example, processors 601 can be configured to perform one or more of any function, method, or operation disclosed herein.

Instruction memory 607 can store instructions that can be accessed (e.g., read) and executed by processors 601. For example, instruction memory 607 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 601 can store data to, and read data from, working memory 602. For example, processors 601 can store a working set of instructions to working memory 602, such as instructions loaded from instruction memory 607. Processors 601 can also use working memory 602 to store dynamic data created during the operation of system 102. Working memory 602 can be a random access memory (RAM) such as a static random access memory (SRAM) or dynamic random access memory (DRAM), or any other suitable memory.

Input-output devices 603 can include any suitable device that allows for data input or output. For example, input-output devices 603 can include one or more of a keyboard, a touchpad, a mouse, a stylus, a touchscreen, a physical button, a speaker, a microphone, or any other suitable input or output device.

Communication port(s) 609 can include, for example, a serial port such as a universal asynchronous receiver/transmitter (UART) connection, a Universal Serial Bus (USB) connection, or any other suitable communication port or connection. In some examples, communication port(s) 609 allows for the programming of executable instructions in instruction memory 607. In some examples, communication port(s) 609 allow for the transfer (e.g., uploading or downloading) of data, such as transaction data.

Display 606 can display user interface 605. User interfaces 605 can enable user interaction with, for example, computing device 112 or 118. For example, user interface 605 can be a user interface for an application of a retailer that allows a customer to purchase one or more items from the retailer. In some examples, a user can interact with user interface 605 by engaging input-output devices 603. In some examples, display 606 can be a touchscreen, in which the touchscreen displays the user interface 605.

Transceiver 604 allows for communication with a network, such as the communication network 118 of FIG. 1. For example, if network 106 of FIG. 1 is a cellular network, transceiver 604 is configured to allow communications with the cellular network. In some examples, transceiver 604 is selected based on the type of network 106 system 102 will be operating in. Processor(s) 601 is operable to receive data from, or send data to, a network, such as network 106 of FIG. 1, via transceiver 604.

Although the embodiments discussed herein are described with reference to the figures, it will be appreciated that many other ways of performing the acts associated with the embodiments can be used. For example, the order of some operations may be changed, and some of the operations described may be optional.

In addition, the embodiments described herein can be at least partially implemented in the form of computer-implemented processes and apparatus. The disclosed embodiments may also be at least partially implemented in the form of tangible, non-transitory machine-readable storage media encoded with computer program code. For example, the processes described herein can be implemented in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the embodiments. The embodiments may also be at least partially implemented in the form of a computer into which computer program code is loaded or executed, such that, the computer becomes a special purpose computer for practicing the embodiments. When implemented on a general-purpose processor, the computer program code segments configure the processor to create specific logic circuits. The embodiments may alternatively be at least partially implemented in application specific integrated circuits for performing the embodiments.

The foregoing is provided for purposes of illustrating, explaining, and describing embodiments of this disclosure. Modifications and adaptations to the embodiments will be apparent to those skilled in the art and may be made without departing from the scope or spirit of the disclosure.

What is claimed is:

1. A system comprising:
a memory having instructions stored thereon, and a processor configured to read the instructions to:
receive anchor item data corresponding to an anchor item;
determine category data corresponding to a category of the anchor item;
identify a label of the anchor item category data, the label indicating whether the anchor item is eligible for upselling;
identify, in response to the label indicating that the anchor item is not eligible for upselling, complementary category data corresponding to the anchor item category data, based on historical transaction data and at least one of co-view data and add-to-cart data; and
generate recommended cross-selling item data from the complementary category data, the recommended cross-selling item data being generated by applying a trending model to historical transaction data of items having complementary category data.

2. The system of claim 1, wherein the anchor item is a cold start item.

3. The system of claim 1, wherein the label of the anchor item category data is a cross-selling label or an upselling label.

4. The system of claim 3, wherein the label of the anchor item category data is identified by applying a clustering algorithm to at least one of the historical transaction data, co-purchase data, the co-view data, and the add-to-cart data.

5. The system of claim 1, wherein the processor is further configured to read the instructions to generate, in response to the label indicating that the anchor item is eligible for upselling, recommended upselling item data from the anchor item category data.

6. The system of claim 5, wherein the recommended upselling item data corresponds to trending items within the anchor item category.

7. The system of claim 5, wherein the processor generates the recommended upselling item data by applying the trending model to historical transaction data of items within the anchor item category and generating a trending score for the items within the anchor item category.

8. The system of claim 7, wherein the trending model comprises at least one of an Exponential Decay Model and a Bayesian Ridge Predictive Model.

9. The system of claim 7, wherein the processor generates the recommended upselling item data by ranking the trending scores for the items within the anchor item category.

10. A method comprising:
receiving anchor item data corresponding to an anchor item;
determining category data corresponding to a category of the anchor item;
identifying a label of the anchor item category data, the label indicating whether the anchor item is eligible for upselling;
identifying, in response to the label indicating that the anchor item is not eligible for upselling, complementary category data corresponding to the anchor item category data, based on historical transaction data and at least one of co-view data and add-to-cart data; and
generate recommended cross-selling item data from the complementary category data, the recommended cross-selling item data being generated by applying a trending model to historical transaction data of items having complementary category data.

11. The method of claim 10, wherein the label of the anchor item category data is a cross-selling label or an upselling label.

12. The method of claim 11, wherein identifying the label of the anchor item category data comprises applying a clustering algorithm to at least one of the historical transaction data, co-purchase data, the co-view data, and the add-to-cart data.

13. The method of claim 10, further comprising generating, in response to the label indicating that the anchor item is eligible for upselling, recommended upselling item data from the anchor item category data.

14. The method of claim 13, wherein the recommended upselling item data corresponds to trending items within the anchor item category.

15. The method of claim 13, wherein generating the recommended upselling item data further comprises applying the trending model to historical transaction data of items within the anchor item category and generating a trending score for the items within the anchor item category.

16. A computer program product comprising:
a non-transitory computer readable medium having program instructions stored thereon, the program instructions executable by one or more processors, the program instructions comprising:
receiving anchor item data corresponding to an anchor item;
determining category data corresponding to a category of the anchor item;
identifying a label of the anchor item category data, the label indicating whether the anchor item is eligible for upselling;
identifying, in response to the label indicating that the anchor item is not eligible for upselling, complementary category data corresponding to the anchor item category data, based on historical transaction data and at least one of co-view data and add-to-cart data; and
generate recommended cross-selling item data from the complementary category data, the recommended cross-selling item data being generated by applying a trending model to historical transaction data of items having complementary category data.

17. The computer program product of claim 16, wherein the label of the anchor item category data is a cross-selling label or an upselling label.

18. The computer program product of claim 17, wherein identifying the label of the anchor item category data comprises applying a clustering algorithm to at least one of the historical transaction data, co-purchase data, the co-view data, and the add-to-cart data.

19. The computer program product of claim 16, wherein the program instructions further comprise generating, in response to the label indicating that the anchor item is eligible for upselling, recommended upselling item data from the anchor item category data.

20. The computer program product of claim 19, wherein generating the recommended upselling item data further comprises applying the trending model to historical transaction data of items within the anchor item category and generating a trending score for the items within the anchor item category.
